(19) United States
(12) Patent Application Publication
(10) Pub. No.: US 2006/0278334 A1
(43) Pub. Date: Dec. 14, 2006

(54) METHOD FOR MANUFACTURING AN OPTICAL STORAGE MEDIUM

(75) Inventors: Bernd Heinz, Buchs (CH); Cem Yavaser, Azmoos (CH)

Correspondence Address: PEARNE & GORDON LLP, 1801 EAST 9TH STREET, SUITE 1200, CLEVELAND, OH, 44114-3108, US

(73) Assignee: UNAXIS BALZERS LTD., Balzers (LI)

(21) Appl. No.: 11/423,164

(22) Filed: Jun. 9, 2006

Related U.S. Application Data
(60) Provisional application No. 60/690,376, filed on Jun. 14, 2005.

(51) Int. Cl. B32B 37/00; B32B 38/04; B32B 37/26

(52) U.S. Cl. 156/275.5; 156/275.7; 156/289

(57) ABSTRACT

In a method for manufacturing an optical storage medium a first 1 and a second circular substrate 2 are being provided and being joined by means of a W curable resin forming an intermediate bonding layer. Then said two bonded substrates are being illuminated with UV light with the exception of the very outer edge of the bonded disc. Afterwards said two bonded disks are being spun and thereby a removal of unwanted resin (adhesive) from the outer edge takes place.

This invention is useful in optical disc production, e.g. DVD-14/18, DVD+R Double Layer, Blu Disk Double Layer and other multi-layer media.

### BACKGROUND OF THE INVENTION

The common way to produce a dual layer single side DVD (like DVD-9) is to bond two 0.6 mm substrates together each carrying an information layer. But there are other ways to make a double layer disk. Instead of forming one layer in each substrate, those techniques use a single substrate structure with two internal information layers. This is not necessary for DVD-9 production but for other multilayer formats like DVD14/18 or DVD+R DL.

In the first step a first substrate with an information layer is produced by injection moulding and coated with layer material, which is appropriate for the format. Then a second substrate is produced with a second information layer—this second substrate is bonded together with the first substrate using typically a UV-curing adhesive. In the next step the 2 substrates are separated again, whereby the U resin with the image of the information layer of the second substrate must remain completely at the first substrate (transfer process) Depending on the application it is also possible to transfer a metallic layer in a similar way from the second to the first substrate.

For a good stamping or layer transfer result and an easy separation the material choice for the 2 substrates are important. The adhesion of the second substrate to the adhesive or the transfer layer has to be lower than the adhesion of all the other layers on the first substrate. Whereas polycarbonate is typically used for the first substrate, non-polar materials like PMMA are typically used for the second substrate. Alternatively the second substrate can be coated with an anti-adhesive coating for easy separation.

Due to the nature of the bonding process there will be a certain amount of resin at the outer edge of the 2 substrates. Whereas this extra amount of adhesive might be favourable for standard DVD production for a good sealing against the penetration of moisture it is a serious problem for the described processes for double/multilayer disk formation. Reason: After separation of the second substrate this adhesive material remains connected to the bonding layer and/or the first substrate. Due to its brittleness, the hardened adhesive forms a sharp rim around the first substrate and dust or particles can easily be created. Sticking on the surface of the media those particles are lowering the production yield significantly.

Furthermore, this sharp rim is causing process problems for the subsequent production steps. Cover layer formation for Blu disk, Dye coating using a spinning process (in the case of DVD+R DL) or final bonding to finish the DVD will be difficult unless measures are being taken to clean the outer edge.

### RELATED ART

WO 03/98 607 describes a method to influence the thickness distribution in a layer of lacquer or adhesive on a single substrate. The fluid lacquer or adhesive is spin-distributed on a rotating substrate. By means of an adjustable diaphragm, different regions of the substrate are then exposed to U radiation. This way a kind of radially increasing hardening gradient is being achieved. An outer peripherical zone may be shielded in order to avoid exposure of the liquid lacquer to radiation.

However, with the invention at hand two bonded substrates are being used, which means, that the lacquer has to be cured by exposing it through the top (or bottom) substrate. The substrates however tend to deflect, reflect or absorb at least partially the UV-radiation.

### SOLUTION ACCORDING TO THE INVENTION

To solve the problem of adhesive around the outer edge according to this invention, the adhesive is removed from the outer edge in the low viscosity state before final curing with the following procedure. After joining of the two substrates the disk is illuminated with UV light, whereby measures are taken that the very outer edge of disk is shadowed from the UV light to prevent a hardening of the resin in this area. A viscosity difference of the bonding layer results due to this selective illumination: a high viscosity (hardened) state in the inner area and the information area and a lower viscosity state at the outer edge of the bonded disk.

In the next step, the disk will be rotated with a certain rotation speed. The lacquer in the high viscosity state will remain mostly unchanged, whereas the lacquer in the low viscosity state is mobile enough to be removed from the outer edge of the disk. In this spinning step the unwanted adhesive at the outer edge will be removed without changing the thickness distribution of the bonding layer in the information area of the disk.

Optionally, in a last process step the final curing of the disk has to be done if necessary.

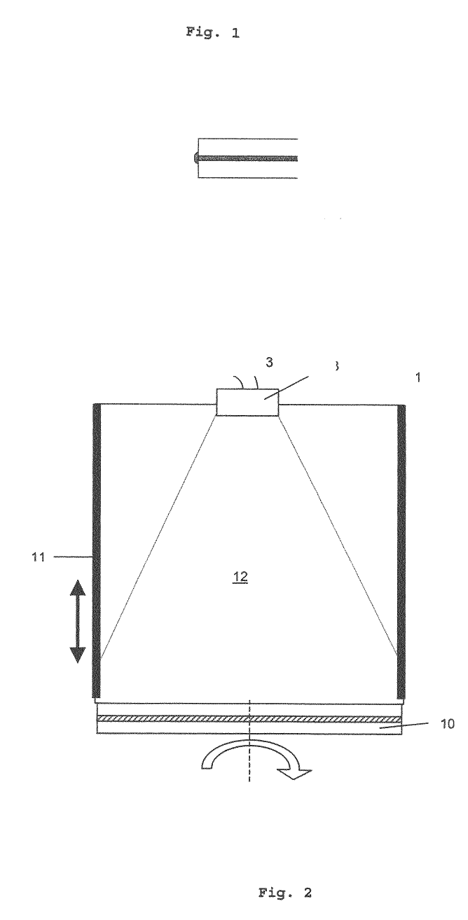

FIG. 1 shows a schematic overview over two bonded discs

FIG. 2 shows a mask for the U curing of two bonded substrates according to an embodiment of the invention.

FIG. 1 illustrates a method for manufacturing an optical storage medium. After having provided a first 1 and a second circular substrate 2, said substrates 1, 2 are being joined by means of a UV curable resin forming an intermediate bonding layer 3. Then said two bonded substrates are being illuminated with UV light with the exception of the very outer edge of the bonded disc. Afterwards said two bonded disks are being spun and thereby a removal of unwanted resin (adhesive) 4 from the outer edge takes place.

With reference to FIG. 2, according to a special embodiment of the invention the 2 bonded substrates (lacquered disc) 10 are placed on a rotating table (not shown) underneath a UV lamp 13. A movable mask 11 is brought close to the surface of the disk. The mask 11 is shadowing the outer area of the disk 10 when the UV light 12 is switched on. It is possible to rotate the disk during illumination with a low rotation speed.

After the curing step the disk has to be accelerated to higher rotation speed to spin-off the outer edge lacquer. Spinning speed and time have to be carefully selected to prevent a change in the bonding layer in the information area of the disk.

Typical process parameters for the edge cleaning of 120 mm substrates are:

| | | |
|---|---|---|
| Curing intensity: | 50 | mW/cm2 |
| Curing time: | 1 | s |
| Final spin speed: | 2000 | rpm |
| Mask diameter: | 118 | mm |
| Distance mask-disk: | 0.5 | mm |
| Initial viscosity of the bonding lacquer: | 580 | mPas |

In comparison with other techniques where the outer edge of the disks is cleaned after the final curing step, the removal of the adhesive from the outer edge in the uncured low viscose state avoids the risk of creating dust particles during cleaning. Those dust particles can be a potential reason for a low production yield.

What is claimed is:

1. A method for manufacturing an optical storage medium comprising the following steps:
(a) providing a first (1) and a second (2) circular substrate
(b) joining said substrates by means of a UV curable resin forming an intermediate bonding layer (3)
(c) illuminating said two bonded substrates with UV light (12) with the exception of the very outer edge of the bonded disc
(d) spinning said two bonded disks and thereby removing unwanted resin (4) from the outer edge.

2. A method according to claim 1, further comprising
(e) curing the two bonded disks finally with UV light

3. A method according to claim 1, wherat the two bonded discs are being rotated during illumination in step (c)

4. A method according to claim 1, whereat a movable mask (11) is brought close to the surface of the two bonded disks (10) prior to illumination in step (c).

5. A method according to claim 4, whereat the mask (11) shadowing about 1 mm of the outer area of the disk during UV illumination in step (c).

6. A method according to claim 1, wherein the first (1) and second (2) substrates each carry an information layer.

7. A method according to claim 1, wherein the first substrate (1) is made from polycarbonate and the second substrate (2) is made from PMMA.

8. A method according to claim 1, wherein the first (1) and second (2) substrate are made from the same material and the second substrate (2) is covered with an anti-adhesive coating for later easy separation.
